(19) United States
(12) Patent Application Publication
(10) Pub. No.: US 2019/0176351 A1
(43) Pub. Date: Jun. 13, 2019

(54) HAIR TEXTURING SCISSORS

(71) Applicants: Chao Wei, Chattanooga, TN (US); Tengzhang Xu, Xiamen (CN)

(72) Inventors: Chao Wei, Chattanooga, TN (US); Tengzhang Xu, Xiamen (CN)

(21) Appl. No.: 15/986,981

(22) Filed: May 23, 2018

(30) Foreign Application Priority Data
Dec. 11, 2017 (CN) 201721244686.4

(51) Int. Cl. B26B 13/24; B26B 13/20

(52) U.S. Cl. CPC B26B 13/24; B26B 13/20

(57) ABSTRACT

A hair texturing scissors is provided. Each texture scissor has uneven teeth for selective hair weight removal. The texture scissor provides a second scissor element pivotally connected to a blade portion. The second scissor element carries a plurality of spaced apart teeth, wherein the width and length of the teeth different from tooth to tooth in relation to a distance from the distal end of the second scissor element. As a result, the width of the interval spaced between adjacent teeth accordingly changes from the distal end to the proximal end of the second scissor element. Moreover, tooth form, width, and interval influence the hair weight removal, and if one of these three elements changes, the cutting percentage changes accordingly, which is enabled simultaneously by the present invention.

### BACKGROUND OF THE INVENTION

The present invention relates to hairdressing scissors and, more particularly, to a hair texturing scissors providing uneven teeth for selective and simultaneously hair weight removal ranging between 5%-50% of hair weight removal, thereby enabling different hairstyles and requirement of customers efficiently through one pair of texturing scissors.

A pair of texturing scissors includes two pieces of blades: a still blade and a movable blade. One piece is made into a tooth form blade, and the other piece is typically made into an arc-shaped blade. Traditional texture shears provide only one type of teeth form, width, and interval along their blade, and so are only adapted for providing one, unchangeable percentage of hair weight removal/cutting, for example either 10% or 20%. As a result, hair dressers would need multiple shears, a different shear for each desired percentage of hair weight removal, which may vary depending on what portion of the head the cut hair is associated with. In many circumstances, this demands hairdressers to switch between multiple texture shears through the whole process of cutting one customer's hair. Such distended processes make it more difficult for hairdressers to efficiently fit each customer into a tight schedule typically full of many back-to-back customers. Furthermore, conventional shears are very expensive and could cost hair dressers as much as one thousand dollars each single pair. In other words, current texture shears work but one size does not fit all.

As can be seen, there is a need for a hair texturing scissors providing uneven teeth for selective hair weight removal, enabling slide cutting ranging from 5-50 percent hair weight removal in any direction with zero drag or pull. The present invention embodies a one-size-fit-all approach allowing one texture shear to efficient provide a selective, simultaneous array of hair weight removal percentages. As a result, this uneven texture shear will not only bring about financial benefits, but also make the hair cutting more effective and efficient.

### SUMMARY OF THE INVENTION

In one aspect of the present invention, a pair of hairdresser scissors includes a blade portion pivotally connected to a scissor element; a plurality of spaced apart teeth perpendicularly extending from the scissor element, each tooth having a distal edge; and a width of each distal edge sequentially increasing or sequentially decreasing from a distal end to a proximal end of the scissor element.

In another aspect of the present invention, the pair of hairdresser scissors includes a blade portion pivotally connected to a scissor element; a plurality of spaced apart teeth perpendicularly extending from the scissor element, each tooth having a distal edge and a concave body portion, wherein each two adjacent teeth of the plurality of teeth are spaced apart by a convex interval; a width of each distal edge sequentially increasing or sequentially decreasing from a distal end to a proximal end of the scissor element; and a longitudinal length of each body portion sequentially increasing from said distal end to said proximal end.

These and other features, aspects and advantages of the present invention will become better understood with reference to the following drawings, description and claims.

### BRIEF DESCRIPTION OF THE DRAWINGS

FIG. 1 is a side elevation view of an exemplary embodiment of the present invention;

FIG. 2 is a detailed side elevation view of an exemplary embodiment of the present invention;

FIG. 3 is a side elevational view of an exemplary embodiment of the present invention;

FIG. 4 is a detail side elevation view of an exemplary embodiment of the present invention; and

FIG. 5 is a schematic view of an exemplary embodiment of the present invention, demonstrating the five general ranges of arrangement of teeth, and how they would enable the simultaneous application of one or more ranges as the present invention pivots between and open and a closed/cutting condition.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hair texturing scissors providing uneven teeth for selective hair weight removal. The texture scissor provides a blade portion pivotally connected to a second scissor element. The second scissor element carries a plurality of spaced apart teeth, wherein the width and length of the teeth different from tooth to tooth in relation to a distance from the distal end of the second scissor element

There are three elements influencing the hair weight removal of a texturing scissors: 1) tooth form: the different structural shape of teeth of the texturing scissors; 2) tooth width:, i.e., the width of the structural shape of the teeth of the texturing scissors; and 3) tooth interval—the distance between the teeth.

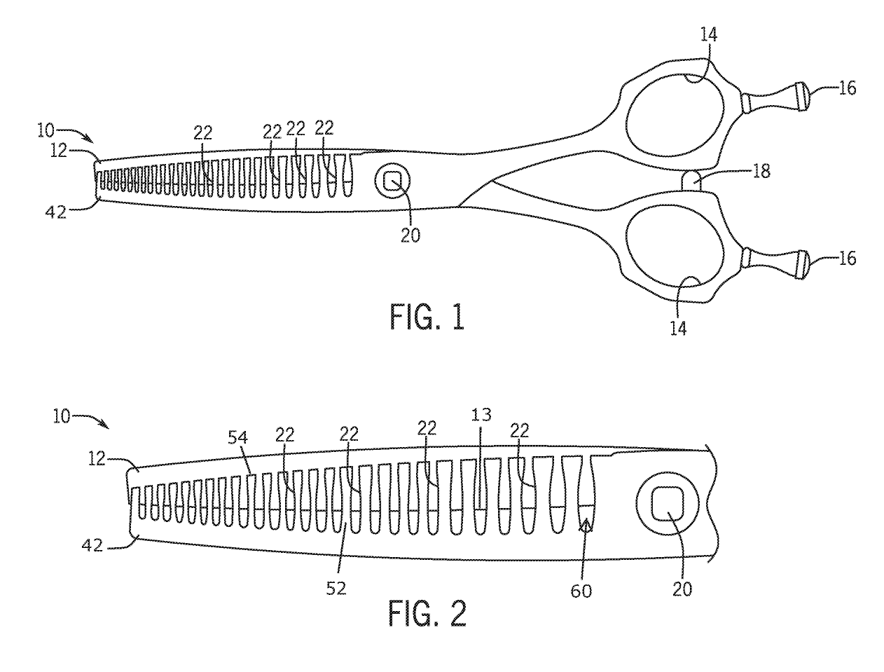

Referring to FIGS. 1 through 5, the present invention may include a texture scissor 10. The texture scissor 10 may include a first scissor element 12 (the movable blade) and a second scissor element 42 or 32 (the still blade) pivotally coupled together at a pivot axle 20. The first and second scissor elements 12 and 32/42 may be provided with finger rings 14 for allowing a user to engage their thumb and ring finger therein for manipulating the texture scissor 10 by selectively actuating the first and second scissor elements 12 and 32/42 about the pivot axle 20 to pivot between open and closed/cutting conditions. One of the finger rings 14 may provide a stop 18 positioned between the opposing ringer ring 14 for defining the closed condition. One or both of the finger rings 14 may have a finger rest 16 so the user can rest his or her little finger or the like thereon.

In the same way, if the user is left handed, one of the finger rings 14 may have a finger rest 16, so the user can rest his or her little fingers of their left hand.

The closing operation of the first and second scissor elements 12 and 32/42 results in a shearing operation. The first scissor element 12 provides a blade portion 13. The second scissor element 32 or 42 provides a plurality of teeth 22 or 34, respectively, each two adjacent teeth 22 or 34 being spaced by a plurality of intervals 60 so that the texture scissor 10 may cut different percentages of hair that is engaged between the blade portion 13 and the relevant teeth 22 or 34.

Each tooth may have a tapered body portion 52 extending from the second scissor element 32/42 to a distal edge 54 so that the distal edge 54 of each tooth is wider than its respective body portion 52. The series of tapered, concave body portions 52 results in convex body intervals 60.

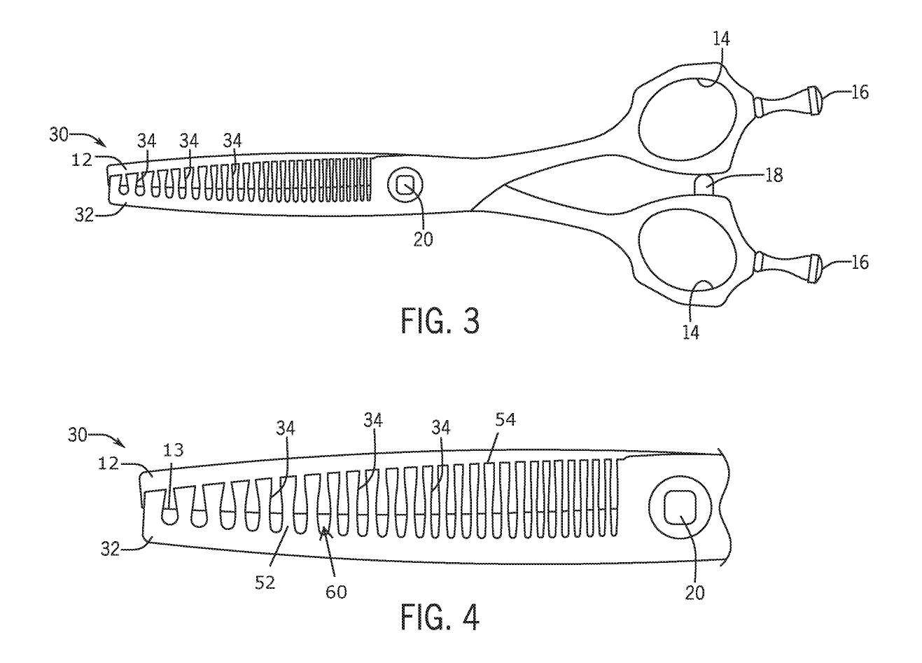

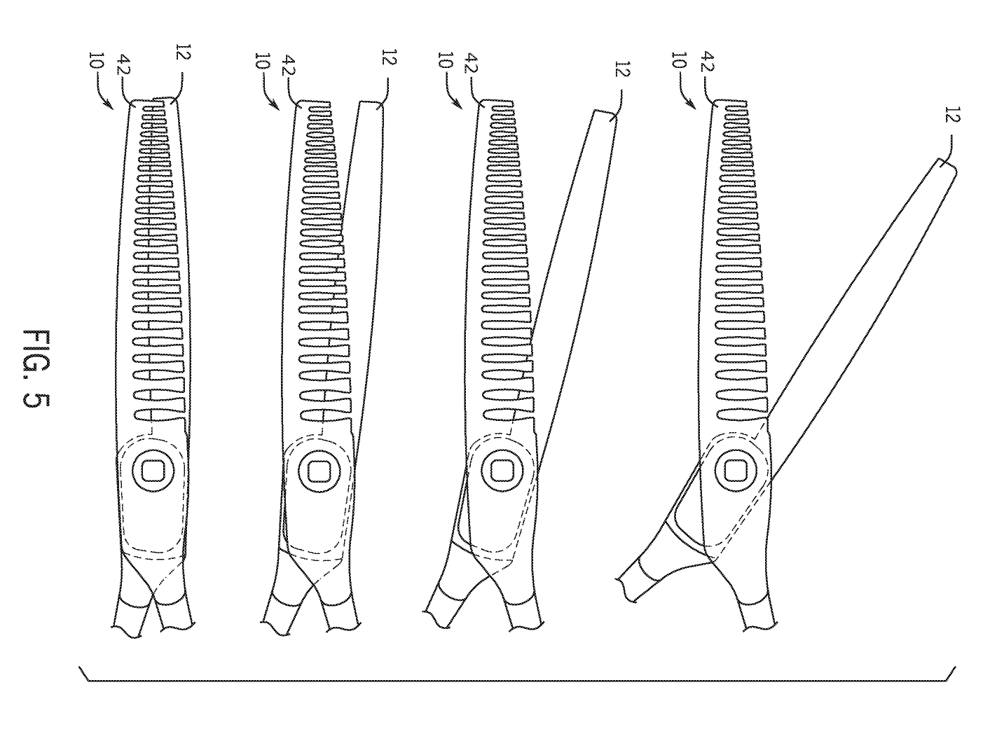

Referring to FIGS. 1 and 2, the present invention embodies the texture scissor 10 providing a second scissor element 42 having the plurality of teeth 22 oriented from finer to coarser teeth 22 (first orientation), from distal to proximal end of the second scissor element 42. Referring to FIGS. 3 and 4, the present invention embodies a second embodiment 30 of the texture scissor wherein the second scissor element 32 having the plurality of teeth 34 oriented from coarser to finer teeth 34 (second orientation), from distal to proximal end of the second scissor element 32. By finer, the applicant means narrower, so that in the first orientation in the body portion 52 width increases with each adjacent tooth 22 closer to said proximal end. The reverse is true in the second orientation. As a result, each adjacent interval space 60 increases from distal end to proximal end in the first orientation, while each adjacent interval space 60 decreases in the second orientation. In each orientation, the overall longitudinal length (orthogonal to the above-mentioned width) increases from distal end to said proximal end.

A method of using the present invention may include the following. The texture scissors 10 and 30 disclosed above may be provided. The user-hairdresser selectively manipulates the texture scissors 10 or 30 so that certain teeth of the plurality of teeth 22 or 34 on the relevant second scissor element 42 or 32 sandwich hair therebetween and the blade portion 13 as desired by the user to perform hair weight removal. Generally, the texture scissors 10 or 30 provides up to five general ranges of percentages of hair to be cut against the blade portion 13: the first range may be for 50-45%; the second range is for 35-40%; the third range is for 30-25%; the fourth range is for 20-15%; and the fifth range is for 10-5% at the proximal or distal end of the second scissor element 32 or 42, depending on the orientation. In the same way, the texturing scissor 10 provides five general ranges of percentages of hair to be cut against the blade portion: the first range is for 5-10%; the second range is for 15-20%; the third range is for 25-30%; the fourth range is for 35-40%; and the fifth range is for 45-50%.

In a hair cutting process of the pair of texturing scissors, as shown in FIG. 5, the pair of scissors is closed sequentially from range 5 to 1 to cut hair in the hair cutting process. If the tooth form, tooth width and tooth interval are all the same, the hair weight removal of the scissors is the same; if one of the three elements of the tooth form, tooth width and tooth interval varies along the second scissor element 32 or 42, the hair weight removal of the scissors is influenced accordingly. The pair of texturing scissors is designed to have different tooth forms and tooth widths and different tooth intervals, so that diversified functions of the texturing scissors can be designed. As a result, the width of the interval spaced between adjacent teeth accordingly changes from the distal end to the proximal end of the second scissor element. Such a novel arrangement of teeth affords the selective hair weight removal across a range of percentages of hair removal using only one texture shear. Furthermore, with one cut, see again FIG. 5, a user can simultaneously remove different percentages of hair depending on the hair's relation to the second scissor element 32 or 42.

The present invention may be used for hair-cutting texture and as thinning shears. When the uneven teeth texturing scissor 10 is actually applied, two or more “ranges” of hair weight removal can be selected from ranges 1, 2, 3, 4, and/or 5 as indicated in FIG. 5, and more distribution designs can also be made for the tooth forms such as a plain, “V” sharp, and an antler sharp of the tooth form.

It should be understood, of course, that the foregoing relates to exemplary embodiments of the invention and that modifications may be made without departing from the spirit and scope of the invention as set forth in the following claims.

What is claimed is:

1. A pair of hairdresser scissors, comprising:
a blade portion pivotally connected to a scissor element;
a plurality of spaced apart teeth perpendicularly extending from the scissor element, each tooth having a distal edge; and
a width of each distal edge sequentially increasing or sequentially decreasing from a distal end to a proximal end of the scissor element.

2. The pair of hairdresser scissors of claim 1, further comprising a longitudinal length of each of the plurality of teeth sequentially increasing from said distal end to said proximal end.

3. The pair of hairdresser scissors of claim 1, wherein each tooth provides a body portion.

4. The pair of hairdresser scissors of claim 3, wherein a width of each body portion is less than the width of each respective distal edge.

5. The pair of hairdresser scissors of claim 3, wherein each body portion concave along each opposing longitudinal edge thereof.

6. The pair of hairdresser scissors of claim 1, each two adjacent teeth of the plurality of teeth are spaced apart by an interval.

7. The pair of hairdresser scissors of claim 5, each two adjacent teeth of the plurality of teeth spaced apart by a convex interval.

8. A pair of hairdresser scissors, comprising:
a blade portion pivotally connected to a scissor element so that they pivot between an open and a closed-cutting condition;
a plurality of spaced apart teeth perpendicularly extending from the scissor element, each tooth having a distal edge and a concave body portion, wherein each two adjacent teeth of the plurality of teeth are spaced apart by a convex interval;
a width of each distal edge sequentially increasing or sequentially decreasing from a distal end to a proximal end of the scissor element; and
a longitudinal length of each body portion sequentially increasing from said distal end to said proximal end,
whereby a user simultaneously removes different percentages of hair depending on a relationship of said hair to the second scissor element on the closed-cutting condition.
